(19) United States
(12) Patent Application Publication
(10) Pub. No.: US 2004/0196422 A1
(43) Pub. Date: Oct. 7, 2004

(54) Semi-transmissive reflective color liquid crystal display device

(75) Inventors: Norihiro Arai, Tokyo (JP); Tsuyoshi Suzuki, Tokyo (JP); Toshiharu Nishino, Tokyo (JP); Kunpei Kobayashi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/812,765

(22) Filed: Mar. 29, 2004

(30) Foreign Application Priority Data
Apr. 1, 2003 (JP) 2003-97982

(51) Int. Cl. G02F 1/1335

(52) U.S. Cl. 349/114

(57) ABSTRACT

A color filter constituted by red, green, and blue color filter elements is formed on an internal surface of a front transparent substrate. A reflective film is provided on a part corresponding to approximately a half of a pixel area on an internal surface of a back transparent substrate. The half of the pixel area on which the reflective film is provided is a reflective portion, and approximately the other half is a transmissive portion. An inter-substrate gap and a thickness of the color filter in the transmissive portion are set such that transmissive display achieving high luminance and high contrast can be realized. A thickness of the color filter and the thickness of a liquid crystal layer in the reflective portion are set to optimal values so that reflective display achieving high contrast can be realized, by adjusting a thickness of a liquid crystal layer thickness adjusting layer.

### BACKGROUND OF THE INVENTION

1. Field of the Invention

The present invention relates to a liquid crystal display device capable of both transmissive display and reflective display.

2. Description of the Related Art

In recent years, a semi-transmissive reflective liquid crystal display device is employed as a display suitable for a portable tool such as a cellular phone, a personal digital assistant, etc. The semi-transmissive reflective liquid crystal display device performs transmissive display which uses a built-in illumination device in a case where the external light, such as the natural light, room illumination, etc. obtained from the environment in which the device itself is used is weak. On the other hand, if the external light is affluently obtained, the semi-transmissive reflective liquid crystal display device switches to reflective display which uses the external light, thereby reducing the electric power consumed by the illumination device.

Such a semi-transmissive reflective liquid crystal display device is constituted by a liquid crystal display element and a backlight provided on one side (back side) of the liquid crystal display element that is counter to the side (front side) viewed by a user. The liquid crystal display element has a structure in which polarizing plates are arranged at the front and the back of a liquid crystal cell provided with a semi-transmissive reflective layer. The semi-transmissive reflective layer is a kind of semi-transmissive reflective plates that make an incident light be reflected thereon and permeate therethrough with a predetermined ratio. The semi-transmissive reflective layer is provided between a back substrate and liquid crystal layer of the liquid crystal cell.

In a case where the semi-transmissive reflective layer, which is a kind of semi-transmissive reflective plates, is used, there is a problem that the brightness of both the reflective display and transmissive display is dark because the reflectance and transmissivity of the semi-transmissive reflective layer are both low.

Unexamined Japanese Patent Application KOKAI Publication No. 2000-111902 proposes a partial reflective transmissive liquid crystal display device in which a reflective portion and a transmissive portion are provided per pixel. However, such semi-transmissive reflective liquid crystal display devices have a problem that they can not achieve an excellent display quality in both the reflective display and transmissive display.

For the above reason, it is quite difficult for the semi-transmissive reflective color liquid crystal display device to achieve an excellent color display quality with necessary light intensity, color purity, and contrast, in both the reflective display and the transmissive display.

The content of the above-indicated publication is incorporated herein.

### SUMMARY OF THE INVENTION

The object of the present invention is to provide a semi-transmissive reflective color liquid display device having a high color display quality with necessary light intensity, color purity and contrast in both the transmissive display and the reflective display.

To achieve the above object, a liquid crystal display device according to a first aspect of the present invention comprises:

a liquid crystal element which includes

a front substrate which is arranged at a front side from where a screen is viewed,

a back substrate which is arranged at a back of the front substrate so as to be opposed to the front substrate,

at least one first electrode which is formed on one of an internal surface of said front substrate and an internal surface of said back substrate, the internal surfaces being opposed to each other,

at least one second electrode which is arranged on the other of the internal surfaces opposed to each other so as to be opposed to the at least one first electrode, thereby forming at least one pixel in an area where the at least one first electrode and the at least one second electrode are opposed to each other,

a liquid crystal layer which is sandwiched between the front substrate and the back substrate,

at least one reflective film which is provided at a back of the liquid crystal layer so as to correspond to a part of the at least one pixel, such that a reflective portion for reflecting an incident light and a transmissive portion which is a region other than the reflective portion and through which an incident light permeates are formed in the at least one pixel,

a color filter which is provided on one of the internal surfaces opposed to each other so as to correspond to the at least one pixel, and

a liquid crystal layer thickness adjusting layer which is provided on at least a region corresponding to the reflective portion between the front substrate and the back substrate, in order to adjust a thickness of the liquid crystal layer in the reflective portion with respect to a thickness of the liquid crystal layer in the transmissive portion in accordance with a thickness of the color filter;

a front polarizing plate and a back polarizing plate which are arranged at a front and a back of the liquid crystal element; and

a backlight which is arranged at a back of the back polarizing plate.

According to the liquid crystal display device of the first aspect, a semi-transmissive reflective color liquid crystal display device having at least one pixel in which a reflective portion and a transmissive portion are provided is realized. In this semi-transmissive reflective color liquid crystal display device, the liquid crystal layer thickness adjusting layer is provided in a region corresponding to at least the reflective portion between the front substrate and the back substrate, in order to adjust the thickness of the liquid crystal layer in the reflective portion with respect to the thickness of the of the liquid crystal layer in the transmissive portion in accordance with the thickness of the color filter. Due to this, the thickness of the color filter and the thickness of the liquid crystal layer can be optimally set in both of the transmissive portion and the reflective portion. At the same time, an excellent display quality with sufficient color purity and light intensity, and with high contrast can be obtained in both of the transmissive display and the reflective display.

A thickness of the liquid crystal layer thickness adjusting layer may be set such that a thickness of the color filter in the reflective portion is thinner than a thickness of the color filter in the transmissive portion, and the thickness of the liquid crystal layer in the reflective portion is thinner than the thickness of the liquid crystal layer in the transmissive portion.

Due to this, the thickness of the color filter and the thickness of the liquid crystal layer can be optimally set in both of the reflective portion and the transmissive portion. An excellent display quality in which the color purity and the light intensity are both high and the contrast is also sufficiently high can be obtained in both of the transmissive display and the reflective display.

A thickness of the liquid crystal layer thickness adjusting layer may be set such that a thickness of the color filter in the reflective portion is equal to a thickness of the color filter in the transmissive portion, and the thickness of the liquid crystal layer in the reflective portion is thinner than the thickness of the liquid crystal layer in the transmissive portion.

Due to this, a necessary light intensity and color purity are secured in both of the transmissive display and the reflective display, and at the same time, an excellent color display with a sufficiently high contrast can be obtained. Further, fabrication of a liquid crystal display device can be facilitated.

Or, a thickness of the liquid crystal layer thickness adjusting layer may be set such that a thickness of the color filter in the reflective portion is thinner than a thickness of the color filter in the transmissive portion, and the thickness of the liquid crystal layer in the reflective portion is equal to the thickness of the liquid crystal layer in the transmissive portion.

Due to this, an excellent color display with sufficiently high color purity and light intensity and with a necessary contrast secured can be obtained in both of the transmissive display and the reflective display. A high yield of liquid crystal display devices can be realized.

The liquid crystal display device may further comprise a flattening film which formed on the color filter in order to flatten a surface of the color filter having different thicknesses. In this case, it is preferred that the liquid crystal element be an STN (Super Twisted Nematic) liquid crystal display element. Or, it is preferred that the liquid crystal element comprise a homogeneous liquid crystal layer in which liquid crystal molecules are oriented substantially in parallel with surfaces of a pair of substrates without being twisted between the substrates in a non electric field state where no electric field is applied.

The liquid crystal layer thickness adjusting layer may be made of a transparent insulation film. The color filter may have a hole which is formed by removing a part of the color filter, at a portion corresponding to the reflective portion of the at least one pixel. Further, the liquid crystal layer thickness adjusting layer may be formed so as to fill the hole formed in the color filter and to cover the color filter.

The liquid crystal layer thickness adjusting layer may be formed on a surface of one of the front substrate and the back substrate, and the color filter may be formed such that a part of the color filter covers the liquid crystal layer thickness adjusting layer. Further, the reflective layer may have a reflective surface on which depressions and protrusions are formed.

It is preferred that a value of a product Δn·d1 of a thickness d1 and a refractive index anisotropy Δn of the liquid crystal layer in the reflective portion be set to a value which makes the liquid crystal layer provide a retardation of ¼ wavelength to a transmitting light in a non electric field state in which substantially no electric field is applied between electrodes opposed to each other, and that a value of a product Δn·d2 of a thickness d2 and a refractive index anisotropy Δn of the liquid crystal layer in the transmissive portion be set to a value that makes the liquid crystal layer provide a retardation of ½ wavelength to a transmitting light in the non electric field state.

It is preferred that the liquid crystal display device further comprise a front retardation plate and a back retardation plate which are respectively arranged between the front polarizing plate and the liquid crystal layer and between the back polarizing plate and the liquid crystal layer such that their slow axes are orthogonal to each other, and which provide a retardation of ¼ wavelength to a transmitting light, that the front polarizing plate and the back polarizing plate be arranged such that their transmission axes are orthogonal to each other, and that the front retardation plate be arranged so as to cancel the retardation provided to the transmitting light by the liquid crystal layer in the non electric field state.

This structure allows the intensity of the light emitted in a bright display to be maximized, and leakage of light in a dark display to be minimized. That is, it becomes possible to heighten the display contrast as much as possible.

It is preferred that the liquid crystal display device further comprise a scattering reflective plate which is arranged between the front polarizing plate and the liquid crystal layer and which scatters a transmitting light.

A liquid crystal display device according to a second aspect of the present invention comprises:

a liquid crystal element which includes

a front substrate which is arranged at a front side from where a screen is viewed,

a back substrate which is arranged at a back of the front substrate so as to be opposed to the front substrate,

at least one opposite electrode which is formed on an internal surface of the front substrate that is opposed to the back substrate,

a plurality of pixel electrodes which are arranged on an internal surface of the back substrate that is opposed to the front substrate so as to be opposed to the at least one opposite electrode, thereby forming a plurality of pixels in areas where the at least one opposite electrode and the plurality of pixel electrodes are opposed to each other,

a liquid crystal layer which is sandwiched between the front substrate and the back substrate,

a plurality of reflective films which are provided on the internal surface of the back substrate so as to respectively correspond to parts of the plurality of pixels, such that a reflective portion for reflecting an incident light and a transmissive portion which is a region other than the reflective portion and through which an incident light permeates are formed in each of the plurality of pixels,

a color filter which is provided on the internal surface of the front substrate that is opposed to the back substrate, so as to correspond to the plurality of pixels, and

liquid crystal layer thickness adjusting layers which are provided on regions corresponding to at least the reflective portions on the color filter formed on the internal surface of the front substrate that is opposed to the back substrate, in order to make a thickness of the liquid crystal layer in the reflective portions thinner than a thickness of the liquid crystal layer in the transmissive portions;

a front polarizing plate and a back polarizing plate which are arranged at a front and a back of the liquid crystal element; and

a backlight which arranged at a back of the back polarizing plate.

According to the liquid crystal display device of the second aspect, liquid crystal layer thickness adjusting layers are provided on regions of the color filter that correspond to at least the reflective portions, such that the thickness of the liquid crystal layer in the reflective portions is thinner than the thickness of the liquid crystal layer in the transmissive portions. Due to this, the thickness of the color filter and the thickness of the liquid crystal layer can be optimally set in both of the transmissive portions and the reflective portions. As a result, an excellent display quality with sufficient color purity and light intensity and also with a high contrast can be obtained in both of the transmissive display and the reflective display.

It is preferred that thicknesses of the respective liquid crystal layer thickness adjusting layers be set such that a thickness of the color filter in the reflective portions is equal to a thickness of the color filter in the transmissive portions, and the thickness of the liquid crystal layer in the reflective portions is thinner than the thickness of the liquid crystal layer in the transmissive portion, that the color filter have holes formed by removing parts of the color filter, at portions corresponding to the reflective portions of the plurality of pixels, and that the liquid crystal layer thickness adjusting layers be formed so as to fill the holes formed in the color filter and to cover the color filter.

A liquid crystal display device according to a third aspect of the present invention comprises:

a liquid crystal element which includes

a front substrate which is arranged at a front side from where a screen is viewed,

a back substrate which is provided at a back of the front substrate so as to be opposed to the front substrat,

at least one opposite electrode which is formed on an internal surface of the front substrate that is opposed to the back substrate,

a plurality of pixel electrodes which are arranged on an internal surface of the back substrate that is opposed to the front substrate so as to be opposed to the at least one opposite electrode, thereby forming a plurality of pixels in an area where the at least one opposite electrode and the plurality of pixel electrodes are opposed to each other,

a liquid crystal layer which is sandwiched between the front substrate and the back substrate,

a plurality of reflective films which are provided on the internal surface of the back substrate so as to respectively correspond to parts of the plurality of pixels, such that a reflective portion for reflecting an incident light and a transmissive portion which is a region other than the reflective portion and through which an incident light permeates are formed in each of the plurality of pixels,

a liquid crystal layer thickness adjusting layer which is provided on the internal surface of the front substrate that is opposed to the back substrate so as to correspond to at least the reflective portions of the plurality of pixels, in order to make a thickness of the liquid crystal layer in the reflective portions thinner than a thickness of the liquid crystal layer in the transmissive portions, and

a color filter which covers the liquid crystal layer thickness adjusting layer on the internal surface of the front substrate that is opposed to the back substrate, and which is provided so as to correspond to the plurality of pixels;

a front polarizing plate and a back polarizing plate which are arranged at a front and a back of the liquid crystal element; and

a backlight which is arranged at a back of the back polarizing plate.

According to the liquid crystal display device of the third aspect, the liquid crystal layer thickness adjusting layer is provided on the internal surface of the front substrate so as to correspond to at least the reflective portions of the pixels, such that the thickness of the liquid crystal layer in the reflective portions is thinner than the thickness of the liquid crystal layer in the transmissive portions. And the color filter corresponding to the plurality of pixels is formed so as to cover the liquid crystal layer thickness adjusting layer. Due to this, the thickness of the color filter and the thickness of the liquid crystal layer can be optimally set in both of the transmissive portions and the reflective portions. Further, an excellent display quality with sufficient color purity and light intensity and with a high contrast can be obtained in both of the transmissive display and the reflective display.

It is preferred that a thickness of the color filter in the reflective portions be thinner than a thickness of the color filter in the transmissive portions, that a thickness of the liquid crystal layer thickness adjusting layer be set such that the thickness of the liquid crystal layer in the reflective portions is thinner than the thickness of the liquid crystal layer in the transmissive-portions, and that the color filter have holes formed by removing parts of the color filter, at portions corresponding to the reflective portions.

### BRIEF DESCRIPTION OF THE DRAWINGS

These objects and other objects and advantages of the present invention will become more apparent upon reading of the following detailed description and the accompanying drawings in which:

FIG. 1 is a perspective diagram showing a dissected liquid crystal display device as a first embodiment of the present invention;

FIG. 2 is an exemplary cross sectional diagram showing the main part of the liquid crystal display device of the first embodiment;

FIG. 3A and FIG. 3B are diagrams showing how a light is polarized in the liquid crystal display device of the first embodiment in case of reflective display, where FIG. 3A shows the state of a polarized light when it is an off time and FIG. 3B shows the state of a polarized light when it is an on time;

FIG. 4A an FIG. 4B are diagrams showing how a light is polarized in the liquid crystal display device of the first embodiment in case of transmissive display, where FIG. 4A shows a state of a polarized light when it is an off time and FIG. 4B shows a state of a polarized light when it is an on time;

FIG. 5 is an exemplary cross sectional diagram showing the main parts of a liquid crystal display device as a second embodiment of the present invention;

FIG. 6 is an exemplary cross sectional diagram showing the main part of a liquid crystal display device as a third embodiment of the present invention; and

FIG. 7 is an exemplary cross sectional diagram showing the main part of a liquid crystal display device as a fourth embodiment of the present invention.

### DETAILED DESCRIPTION OF THE PREFERRED EMBODIMENTS

Liquid crystal display devices will be described below as embodiments of the present invention with reference to the accompanying drawings.

[First Embodiment]

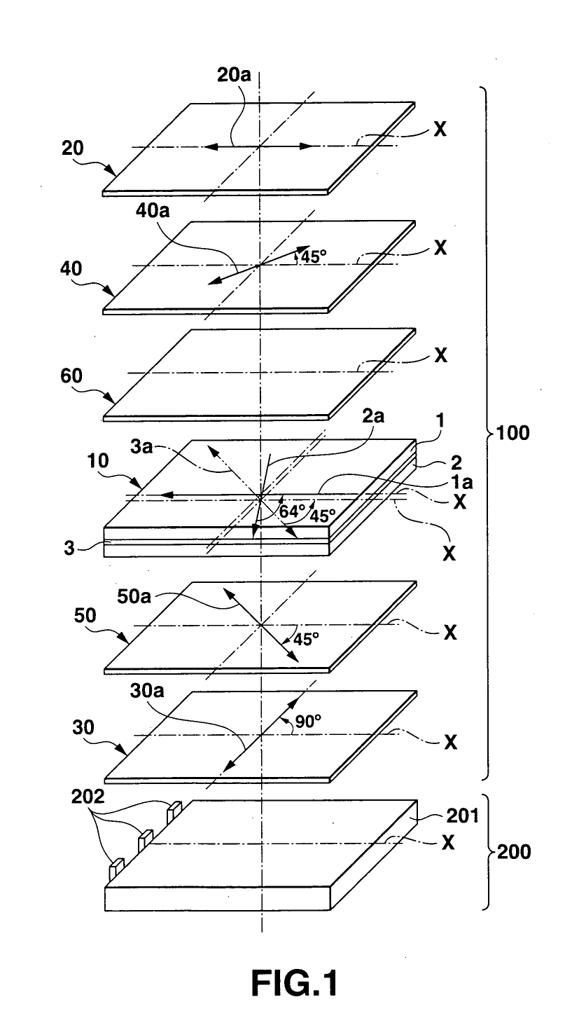

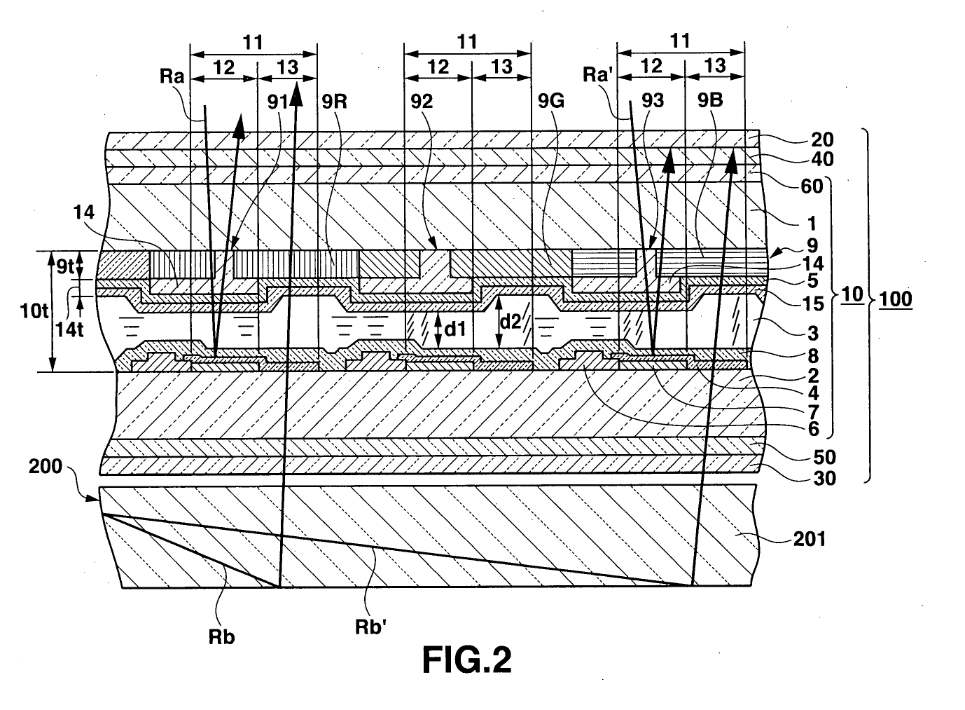

A liquid crystal display device as a first embodiment of the present invention will now be explained with reference to FIG. 1 and FIG. 2. FIG. 1 is a perspective diagram showing a liquid crystal display device according to the present embodiment which is dissected. FIG. 2 is an exemplary cross sectional diagram showing the main parts of the liquid crystal display device.

The liquid crystal display device according to the present embodiment is a semi-transmissive reflective color liquid crystal display device which is used as a display of a cellular phone. As shown in FIG. 1, this liquid crystal display device comprises a liquid crystal display element 100 and a backlight 200 which is an area light source arranged at the back of the liquid crystal display element 100 (arranged at the side counter to the side from which the screen is viewed). The liquid crystal display element 100 comprises a liquid crystal cell 10, a front polarizing plate 20 arranged at the front of the liquid crystal cell 10 (arranged at the viewing side), a back polarizing plate 30 arranged at the back of the liquid crystal cell 10, a front retardation plate 40 provided between the liquid crystal cell 10 and the front polarizing plate 20, a back retardation plate 50 provided between the liquid crystal cell 30 and the back polarizing plate 30, and a light scattering plate 60 provided between the front retardation plate 40 and the liquid crystal cell 10. The light scattering plate 60 is provided to prevent mirror reflection and mirroring of an external view. In the present embodiment, a directional scattering reflective plate which efficiently scatters only incident lights that enter at angles within a specific range is used as the light scattering plate 60. Due to this, image blur and decrease in brightness caused by the light scattering layer being arranged at the front of the liquid crystal cell 10 can be prevented.

As shown in FIG. 2, a front transparent substrate 1 and back transparent substrate 2 of the liquid crystal cell 10 is coupled to each other by an unillustrated frame-like seal member with a predetermined gap kept therebetween. A liquid crystal layer 3 is formed by filling liquid crystal in the space enclosed by the seal member.

The liquid crystal display element 100 of the present embodiment is an active matrix type liquid crystal display element. The liquid crystal layer 3 formed by filling liquid crystal between the transparent substrates 1 and 2 is a TN (Twisted Nematic) type liquid crystal layer. That is, a plurality of pixel electrodes 4 made of a transparent conductive film such as an ITO (Indium Tin Oxide) film or the like are arranged in a matrix on the surface of the back transparent substrate 2 that is opposed to the front transparent substrate 1 (this surface will hereinafter be referred to as internal surface). On the other hand, a later-described single-film-like opposing electrode 5 is provided on the internal surface of the front transparent substrate 1 that is opposed to the back transparent substrate 2. The region where each pixel electrode 4 and the opposing electrode 5 are opposed to each other constitutes a pixel which is the smallest unit for displaying an image. This region possessed by one pixel defines one pixel area 11.

Each pixel electrode 4 is provided with a TFT (Thin Film Transistor) 6 as a switching element for controlling application of a signal voltage. Each TFT 6 is connected to unillustrated gate line and drain line. Each TFT 6 is turned on and off in accordance with various drive voltages supplied through these lines. By each TFT 6 being turned on, a signal voltage is applied to each pixel electrode 4.

A reflective film 7 is provided between a part of each pixel electrode 4 and the back transparent substrate 2. The reflective film 7 is provided on a predetermined part within one pixel area 11 in which one pixel electrode 4 is arranged.

Specifically, the reflective film 7 is provided on at least a part within each pixel area 11 of the liquid crystal cell 10. Due to this, in one pixel, a reflective portion 12 in which the reflective film 7 is provided thereby an incident light entering from the front is reflected and emitted frontward, and a transmissive portion 13 in which the reflective film 7 is not provided thereby an incident light entering from the back is emitted frontward therethrough are formed. As a result, the liquid crystal cell 10 of a semi-transmissive reflective type is formed.

The reflective film 7 of the present embodiment is a mirror reflection film made of aluminum alloy or the like and having a high reflectance. The reflective film 7 is formed on unillustrated gate insulation film and interlayer insulation film which are formed on the internal surface of the back transparent substrate 2. The pixel electrode 4 is formed on the back transparent substrate 2 so as to cover the reflective film 7 by a part of the pixel electrode 4. The reflective film 7 is provided on a region corresponding to substantially half the pixel area 11. Therefore, the half region on which the reflective film 7 is provided is the reflective portion 12, and the other half region is the transmissive portion 13.

A back aligning film 8 is formed substantially uniformly on the back transparent substrate 2, such that all the pixel electrodes 4 and TFTs 6 are covered. An aligning treatment such as rubbing and the like is applied in a predetermined direction to the surface of the back aligning film 8 that contacts the liquid crystal, in order for the liquid crystal molecules of the liquid crystal layer 3 to be twist-aligned. Due to this, the liquid crystal molecules contacting the surface of the back aligning film 8 are oriented in the predetermined direction.

A color filter layer 9 is formed on the internal surface of the front transparent substrate 1. The color filter layer 9 of the present embodiment is constituted by color filter elements 9R, 9G, and 9B colored in red, green, and blue. The color filter elements 9R, 9G, and 9B are arranged in a predetermined order in the pixel areas 11 in which the pixel electrodes 4 are provided. According to the present embodiment, each of the color filter elements 9R, 9G, and 9B is formed to have a fixed thickness 9t at least within the entire corresponding pixel area 11. That is, for example, a given pixel area 11 includes the reflective portion 12 in which the red color filter element 9R is formed and the transmissive portion 13 in which the red color filter element 9R having the same thickness as the red color filter element 9R in the reflective portion 12 is formed. In this case, the thickness 9t of the color filter elements 9R, 9G, and 9B is set so that necessary light intensity and color purity can be secured in both the transmissive color display using the transmissive portion 13 and the reflective color display using the reflective portion 12. In the present embodiment, the color filter elements 9R, 9G, and 9B are formed to have a thickness by which sufficient color purity and light intensity can be obtained in the transmissive color display.

Cylindrical or square-pillar-like holes 91 to 93 having a predetermined size are respectively opened in portions of the color filter elements 9R, 9G, and 9B that correspond to the reflective portion 12. The respective holes 91 to 93 are opened by removing portions of the color filter elements 9R, 9G, and 9B. It is preferable that the opening area of the holes 91 to 93 opened in the color filter elements 9R, 9G, and 9B is equal to or less than 50% of the entire area of the reflective portion 12. The light intensity in the reflective color display is improved by opening the holes 91 to 93 in the portions of the color filter elements 9R, 9G, and 9B corresponding to the reflective portion 12.

Specifically, of the light that permeates through the front transparent substrate 1 and the like, enters the color filter elements 9R, 9G, and 9B and then is reflected on the reflective film 7, the light that passes through the holes 91 to 93 at least on the way inward (toward the liquid crystal cell 10) or on the way outward (apart from the liquid crystal cell 10) is brighter than the light that permeates through the color filter elements 9R, 9G, and 9B both on the way inward and on the way outward. That is, the reflective light emitted outward from the reflective portion 12 is the mixture of a light having a high color purity that goes and returns through the color filter elements 9R, 9G, and 9B, and a light having a high intensity that passes through the holes 91 to 93. Accordingly, the reflective light emitted outward from the reflective portion 12 is a colored light having a sufficiently high color purity and a sufficiently high intensity.

According to the present embodiment, the opening area of the hole 92 opened in the green color filter element 9G (this hole will hereinafter be referred to as the hole of the green pixel) is larger than the opening areas of the holes 91 and 93 opened in the red and blue color filter elements 9R and 9B (these holes will hereinafter be referred to as the holes of the red pixel and blue pixel). This is because the visual sensitivity toward a green light is the lowest among the visual sensitivities toward a red, green, and blue lights and this difference in visual sensitivity has to be compensated for. Due to the difference in the opening area, the difference in visual sensitivity can be as small as possible among the red, green, blue reflective lights. As a result, a white light which is generated by the mixture of a red, green, and blue reflective lights is closer to a pure white light. That is, the white point and the brightness are improved. In this case, it is preferred that the opening area of the hole 92 of the green pixel be 5 to 50% of the entire area of the green color filter element 9G in the reflective portion 12 (the entire area will hereinafter be referred to as green reflective portion entire area). It is preferred that the opening areas of the holes 91 and 93 of the red and blue pixels be 0 to 50% of the red reflective portion entire area and blue reflective portion entire area, respectively. Further, it is more preferable that the opening area rate of the hole 92 of the green pixel be 20 to 40%, and the opening rates of the holes 91 and 93 of the red and blue pixels be 0 to 30%. According to the present embodiment, the opening area rate of the hole 92 of the green pixel is set to 30%, and the opening rates of the holes 91 and 93 of the red and blue pixels are set to 1%.

Not one but a plurality of the holes 91 to 93 may be provided in each reflective portion 12. In this case, the rate of the total area of the plurality of holes to the entire area of the reflective portion 12 may be set to the same rate as the case where one hole is provided.

A liquid crystal layer thickness adjusting layer 14 for adjusting the thickness of the liquid crystal layer (gap) 3 in each reflective portion 12 is formed on the internal surface of the color filter layer 9 (the lower surface thereof in FIG. 2) so as to correspond to the reflective portion 12 in each pixel area 11. Each liquid crystal layer thickness adjusting layer 14 is made of a transparent organic material such as acryl resin and the like, or a transparent inorganic material such as ITO and the like. Each liquid crystal layer thickness adjusting layer 14 is formed in at least a region corresponding to the reflective portion 12 within a region excluding the transmissive portion 13. Each liquid crystal layer thickness adjusting layer 14 fills each of the holes 91 to 93, and is formed to have a flat internal surface. In a case where the liquid crystal layer thickness adjusting layer 14 is made of an organic resin material, a resin material having fluidity is filled in each of the holes 91 to 93 with no space left by roll coating or spin coating. At this time, the resin material is coated to have a predetermined thickness. Then, by hardening the coated resin material, a gap adjusting layer having a flat internal surface is formed. After this, the gap adjusting layer is patterned by etching or the like so as to cover the necessary portions. By this patterning, the liquid crystal layer thickness adjusting layer 14 is formed. In this manner, the liquid crystal layer thickness adjusting layer 14 can easily formed.

The thickness 14t of the portion of the liquid crystal layer thickness adjusting layer 14 that corresponds to each of the color filter elements 9R, 9G, and 9B (this thickness will hereinafter be referred simply as adjusting layer thickness) is set in accordance with the thickness 9t of the color filter layer 9 such that a liquid crystal layer thickness d1 in the reflective portion 12 is optimized with respect to a liquid crystal layer thickness d2 in the transmissive portion 13. In this case, the liquid crystal layer thicknesses d1 and d2 are set in a manner that a retardation at which a difference, caused by turning on and off of the liquid crystal layer 3, in the intensity of the light emitted toward the viewing side (frontward) is the largest can be obtained in the light paths on the way inward and on the way outward of an external light that goes and returns through the liquid crystal layer 3 in the reflective portion 12, and also in the light path of a transmitting light from the backlight that permeates one-directionally through the liquid crystal layer 3 in the transmissive portion 13. In other words, the liquid crystal layer thicknesses d1 and d2 are set so that a retardation at which the display contrast caused by the turning on and off of the liquid crystal layer 3 is the largest can be obtained in the going light path and returning light path of an external light and in the light path of a transmitting light from the backlight. The optimal setting of the liquid crystal layer thicknesses d1 and d2 will be described layer.

The single-film-like transparent opposing electrode 5 is stacked on the liquid crystal layer thickness adjusting layers 14 and on the color filter layer 9 appearing between the liquid crystal layer thickness adjusting layers 14. A front aligning film 15 is stacked on the opposing electrode 5. Due to this, in each pixel area 11, the liquid crystal layer thickness d1 (the distance between the front and back aligning films 15 and 8) in the reflective portion 12 is thinner than the liquid crystal layer thickness d2 in the transmissive portion 13 by the adjusting layer thickness 14t. In the present embodiment, a substrate gap 10t is kept at a predetermined distance by a substrate gap defining member (unillustrated) which is included in the seal member (unillustrated) coupling the substrates 1 and 2. Therefore, the liquid crystal layer thickness d2 in the transmissive portion 13 is substantially determined by the thickness 9t of the color filter layer 9. The liquid crystal layer thickness d1 in the reflective portion 12 is determined by the thickness 9t of the color filter layer 9 and the adjusting layer thickness 14t. That is, the optimal liquid crystal layer thickness d1 can be obtained by adjusting the adjusting layer thickness 14t in accordance with the substrate gap 10t and thickness 9t of the color filter layer 9 that provide the optimal liquid crystal layer thickness d2.

An aligning treatment such as rubbing or the like is applied in a predetermined direction to the front aligning film 15 as well as the back aligning film 8 opposed to the front aligning film 15 via the liquid crystal layer 3, in order to make the liquid crystal molecules of the liquid crystal layer 3 be twist-aligned. Due to this, the liquid crystal molecules contacting the surface of the front aligning film 15 are oriented in the predetermined direction.

In the liquid crystal display element 100 structured as described above, the optical conditions of the respective components are set as follows, so that a retardation at which the difference (display contrast), caused by the turning on and off of the liquid crystal layer 3, in the intensity of a light emitted toward the viewing side (frontward) is the largest can be obtained in the going and returning light paths of an external light and in the light path of a transmitting light from the backlight.

The front polarizing plate 20 provided at the front of the liquid crystal cell 10 is set such that its transmission axis 20a is parallel with an aligning treatment direction 1a of the front transparent substrate 1 of the liquid crystal cell 10, as shown in FIG. 1. A predetermined aligning treatment is applied to the front aligning film 15 in the direction 1a. The back polarizing plate 30 provided at the back of the liquid crystal cell 10 is set such that its transmission axis 30a is orthogonal to the transmission axis 20a of the front polarizing plate 20.

The front retardation plate 40 provided between the liquid crystal cell 10 and the front polarizing plate 20 and the back retardation plate 50 provided between the liquid crystal cell 10 and the back polarizing plate 30 are λ/4 retardation plates for providing a retardation of λ/4 (λ: wavelength of a transmitting light) between a normal light and abnormal light of a transmitting light. Slow axes 40a and 50a of the front and back retardation plates 40 and 50 are at 45° to the transmission axes 20a and 30a of the front and back polarizing plates 20 and 30 adjacent to the front and back retardation plates 40 and 50, respectively.

The direction 1a of the aligning treatment applied to the front aligning film 15, the direction 2a of the aligning treatment applied to the back aligning film 8, an initial twist angle of the liquid crystal molecules of the liquid crystal layer 3 in a non electric field state (hereinafter referred to as off time) in which substantially no electric field is formed between the pixel electrodes 4 and the opposing electrode 5, a refractive index anisotropy Δn based on the initial twist angle, and liquid crystal layer thicknesses d1 and d2 in the reflective portion 12 and transmissive portion 13 of the pixel area 11 are set as follows.

The liquid crystal layer 3 in the off time, i.e. the liquid crystal layer 3 in which the twist alignment of the liquid crystal molecules is in the initial state, is a kind of optical anisotropic substances that provide a retardation to a transmitting light as well as the retardation plates. Accordingly, in a case where the liquid crystal layer 3 is regarded as a retardation plate, the initial twist alignment of the liquid crystal molecules is set in a manner that a slow axis 3a of the liquid crystal layer 3 is at 45° to a horizontal axis “x” as indicated by a two dot chain line.

Therefore, it is preferable that the initial twist angle of the liquid crystal molecules of the liquid crystal layer 3 in the off time be set at within a range of 60° to 70°. In the present embodiment, the initial twist angle of the liquid crystal molecules is set to 64°. The direction 1a of the front aligning film 15 on the front transparent substrate 1 is set to be parallel with the horizontal axis “x” of the screen of the liquid crystal display device (i.e. the front surface of the front polarizing plate 20). Specifically, the direction 1a is set to a direction indicated by an arrow in FIG. 1 (the direction from the right to the left in FIG. 1). The direction 2a of the back aligning film 8 on the back transparent substrate 2 is set at 64° to the horizontal axis “x”. Specifically, the direction 2a is set to a direction indicated by an arrow in FIG. 1. Due to this, the liquid crystal layer 3 can be obtained in which the aligned liquid crystal molecules are twisted to be at 64° counterclockwise (in a leftward rotational direction) when they are seen in a direction from the front transparent substrate 1 toward the back transparent substrate 2, and the slow axis 3a of the liquid crystal layer 3 is orthogonal to the slow axis 40a of the front retardation plate 40 and parallel to the slow axis 50a of the back retardation plate 50.

The liquid crystal layer thicknesses (gap) d1 and d2 in the reflective portion 12 and transmissive portion 13 of each pixel area 11 are optimally set as follows.

Specifically, the liquid crystal layer thickness d1 in the reflective portion 12 is set such that a product ΔA·d1 of the liquid crystal layer thickness d1 with the refractive index anisotropy Δn in a case where the liquid crystal molecules are in the off-time alignment satisfies an equation (1). In the equation (1) below, λ represents the wavelength of a transmitting light and “k” represents a positive integer including zero.

Δn·d1=λ(2k+1)/4 (1)

On the other hand, the liquid crystal layer thickness d2 in the transmissive portion 13 is set such that a product Δn·d2 of the liquid crystal layer thickness d2 with the refractive index anisotropy Δn in a case where the liquid crystal molecules are the off-time alignment satisfies an equation (2). In the equation (2), λ represents the wavelength of a transmitting light and k′ represents a positive integer including zero.

Δn·d2=λ(2k′+1)/2 (2)

Strictly speaking, because the liquid crystal layer thicknesses in the reflective portion 12 and in the transmissive portion 13 are different from each other, the refractive index anisotropy Δn in the reflective portion 12 and that in the transmissive portion 13 are different from each other in the case where the liquid crystal molecules are in the off-time alignment. However, the difference in the refractive index anisotropy Δn is such that can be ignored, and does not substantially give any influence on total retardations in the light paths.

Specifically, Δn·d1 of the liquid crystal layer 3 in the reflective portion 12 in the present embodiment is set such that retardation that provides a phase difference of λ/4 between a normal light and abnormal light of a transmitting light can be obtained. On the other hand, Δn·d2 of the liquid crystal layer 3 in the transmissive portion 13 is set such that retardation that provides a phase difference of λ/2 between a normal light and abnormal light of a transmitting light can be obtained.

According to the present embodiment, in a case where the liquid crystal layer thickness d1 in the reflective portion 12 is 2 to 4 μm, the liquid crystal layer thickness d2 in the transmissive portion 13 is set to be thicker than the liquid crystal layer thickness d1 by approximately 1.0 μm in the liquid crystal layer 3 having an initial twist angle 60°, and by approximately 0.5 μm in the liquid crystal layer 3 having an initial twist angle of 70°. Due to this, the phase difference provided by the liquid crystal layer 3 to a transmitting light is λ/4 between the reflective portion 12 and the transmissive portion 13. It is preferable that a difference d2−d1 between the liquid crystal layer thicknesses d1 and d2 that satisfy the above equations (1) and (2) respectively be 0.5 μm to 6 μm. Incidentally, it is optimal that in a liquid crystal layer having a homogeneous alignment, the liquid crystal layer thickness d2 in the transmissive portion 13 is approximately double the liquid crystal layer thickness d1 in the reflective portion 12.

The backlight 200, which is an area light source provided at the back of the back polarizing plate 30, comprises a light guiding plate 201 constituted by a transparent plate made of acryl resin or the like, and a plurality of light emitting elements 202 constituted by, for example, LEDs (light emitting diodes) or the like which are arranged so as to be opposed to one end surface of the light guiding plate 201.

In the backlight 200, a light emitted from the light emitting elements 202 is guided by the light guiding plate 201, and emitted from the entire front surface of the light guiding plate 201. The light emitted from the light emitting elements 202 enters the light guiding plate 201 from the one end surface of the light guiding plate 201. The light entering the light guiding plate 201 advances in the light guiding plate 201 while repeating total reflection on the interface between the front surface of the light guiding plate 201 and the air outside the light guiding plate 201 and on the interface between the back surface of the light guiding plate 201 and the air outside the light guiding plate 201, and is eventually emitted from the front surface of the light guiding plate 201. Due to this, a light is emitted from the entire front surface of the light guiding plate 201 toward the back polarizing plate 30. The light source of the backlight 200 is not limited to light emitting elements such as LEDs, but may be a linear light source such as a cold-cathode tube.

According to the liquid crystal display device structured as described above, reflective display which uses an external light can be performed in a case where the illuminance of an external light obtained in the environment in which the liquid crystal display device is used is sufficient, and transmissive display which uses a light emitted from the built-in backlight 200 can be performed in a case where the illuminance of an external light is insufficient, i.e. the external light is dark.

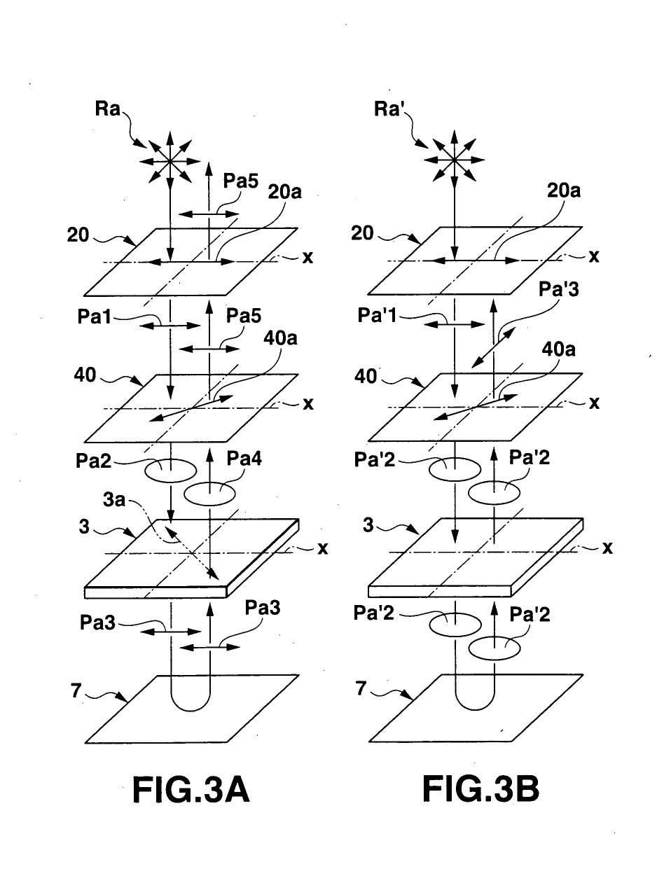

The operation in the reflective display using an external light will be explained with reference to FIG. 2 and FIGS. 3A and 3B. FIGS. 3A and 3B are diagrams showing states of a polarized light in the reflective display. FIG. 3A shows the case of the off time in which no electric field exists, and FIG. 3B shows the case of the on time.

In the liquid crystal cell 10 shown in FIG. 2, a drive voltage in accordance with input information is supplied to each pixel area 11 separately. Due to this, there are formed pixel areas 11 in which no electric field is formed between the electrodes and thus the twist alignment of the liquid crystal molecules is in the initial state (those pixel areas 11 will hereinafter be referred to as off pixels) and pixel areas 11 in which an electric field having a predetermined intensity is formed between the electrodes and thus the liquid crystal molecules are caused to stand upright (those pixel areas 11 will hereinafter be referred to as on pixels). In FIG. 2, the pixel area 11 corresponding to the red color filter element 9R is the off pixel, and the pixel areas 11 corresponding to the green and blue color filter elements 9G and 9B are the on pixels.

For example, an external light (non-polarized) Ra which enters the reflective portion 12 of the off pixel 11 in which the red color filter element 9R is provided turns into a linearly polarized light Pa1 that oscillates along the transmission axis 20a of the front polarizing plate 20 by transmitting through the front polarizing plate 20 as shown in FIG. 3A. Then, the linearly polarized light Pa1 enters the front retardation plate 40. The linearly polarized light Pa1 entering the front retardation plate 40 is provided with a retardation of λ/4 by transmitting therethrough. As a result, the linearly polarized light Pa1 turns into a circularly polarized light Pa2 and enters the liquid crystal cell 10.

The circularly polarized light Pa2 that enters the liquid crystal cell 10 is colored in red by transmitting through the red color filter element 9R. After this, the circularly polarized light Pa2 permeates through the liquid crystal cell 3 being in the off state where the twist alignment of the liquid crystal molecules is in the initial state of 64° and having retardation (Δn·d1) corresponding to the phase difference of λ/4. In the present embodiment, as described above, the liquid crystal layer 3 being in the off state is an optical anisotropic substance that has the slow axis 3a orthogonal to the slow axis 40a of the front retardation plate 40 and provides a retardation of λ/4 to a transmitting light. Therefore, the retardation of λ/4 provided to the circularly polarized light Pa2 by the front retardation plate 4 is canceled by the circularly polarized light Pa2 transmitting through the liquid crystal layer 3. Accordingly, the circularly polarized light Pa2 turns into a linearly polarized light Pa3 that oscillates in the same direction as the former linearly polarized light Pa1, by transmitting through the liquid crystal layer 3 being in the off state. The linearly polarized light Pa3 whose oscillation direction turns back to the former direction is reflected frontward by the reflective film 7.

The linearly polarized light Pa3 that is reflected by the reflective film 7 permeates through the respective films (layers) in an order reverse to the order from the front polarizing plate 20 to the reflective film 7. That is, the linearly polarized light Pa3 permeates through the liquid crystal layer 3 being in the off time and the hole 91 of the red color filter element 9R, and after this, permeates through front retardation plate 40. In the returning path as well as the going path, the retardation provided by the liquid crystal layer 3 in the off time is canceled by the front retardation plate 40. Due to this, the reflected linearly polarized light Pa3 turns into a circularly polarized light Pa4 by transmitting through the liquid crystal layer 3, and then turns into a linearly polarized light Pa5 that oscillates in the same direction as when it is reflected, by transmitting through the front retardation plate 40. Then, the linearly polarized light Pa5 enters the front polarizing plate 20 after transmitting through the front retardation plate 40. Since the oscillation direction of the linearly polarized light Pa5 is parallel to the transmission axis 20a of the front polarizing plate 20, the linearly polarized light Pa5 permeates through the front polarizing plate 20 without being absorbed thereinto, and is emitted frontward to the viewing side. As a result, the off pixel 11 is displayed in red.

The emitted linearly polarized light Pa5 permeates through the red color filter element 9R in the going path and permeates through the hole 91 of the red color filter element 9R in the returning path. That is, the emitted linearly polarized light Pa5 is a bright red light and degradation of whose light intensity is restricted. By this bright red light mixing with a red light emitted from the pixel area 11, a bright red display in which not only the color purity but also the light intensity is sufficiently high is performed in the reflective display.

An external light that enters the transmissive portion 13 of the off pixel 111 turns into a linearly polarized light by transmitting through the liquid crystal layer 3 being in the off state, and after this, permeates through the liquid crystal cell 10 unchangingly as the linearly polarized light without being scatteringly reflected. After this, the linearly polarized light that has permeated through the liquid crystal cell 10 turns into a circularly polarized light by transmitting through the back retardation plate 50. The polarized light component of the circularly polarized light that is parallel to the absorption axis of the back polarizing plate 30 is absorbed by the back polarizing plate 30, and the polarized light component thereof that is parallel to the transmission axis of the back polarizing plate 30 permeates through the back polarizing plate 30 and eventually disappears.

On the other hand, for example, an external light (non-polarized light) Ra′ that enters the reflective portion 12 of the on pixel 11 in which the blue color filter element 9B is provided receives the same effects as those in the off pixel 11 until it permeates through the front polarizing plate 20 and front retardation plate 40 and enters the liquid crystal layer 3. That is, the external light Ra′ turns into a linearly polarized light Pa′1 that oscillates along the transmission axis 20a of the front polarizing plate 20 by transmitting through the front polarizing plate 20, turns into a circularly polarized light Pa′2 by transmitting through the front retardation plate 40, and enters the liquid crystal layer 3 being in the on time.

In the liquid crystal layer 3 being in the on time, the liquid crystal molecules stand upright due to an electric field formed between the electrodes. The retardation (Δn·d1), possessed by the liquid crystal layer 3 in which the liquid crystal molecules stand upright, with respect to a light that permeates through the liquid crystal layer 3 in the direction of its thickness is substantially zero. Therefore, the entering circularly polarized light Pa′2 permeates through the liquid crystal layer 3 being in the on time without being changed, is reflected by the reflective film 7, again permeates through the liquid crystal layer 3 being in the on time unchangingly as the circularly polarized light Pa′2, and enters the front retardation plate 40. The circularly polarized light Pa′2 that enters the front retardation plate 40 is provided with a retardation of λ/4 by the front retardation plate 40. In this case, since the retardation provided by the liquid crystal layer 3 is substantially zero, the light receives the same effect as that of a case where the light permeates through the same front retardation plate 40 twice continuously. That is, the light transmitting through the front retardation plate 40 is provided with a retardation of λ/4 both in the going path and returning path. That is, the light transmitting through the front retardation plate 40 is provided with a retardation of totally λ/2 in the going path and returning path. The linearly polarized light Pa′3 entering from the front retardation plate 40 to the front polarizing plate 20 corresponds to the linearly polarized light Pa′1 entering from the front polarizing plate 20 to the front retardation plate 40 whose (i.e. the light Pa′1's) plane along the oscillation direction is rotated by 90° (the plane along the oscillation direction will hereinafter be referred to as plane of polarization). That is, the plane of polarization of the linearly polarized light Pa′3 is parallel to the absorption axis (unillustrated) of the polarizing plate 20 that is orthogonal to the transmission axis 20a thereof. Because of this, the linearly polarized light Pa′3 is absorbed by the front polarizing plate 20 and is not emitted to the viewing side (frontward). Accordingly, the on pixel 11 is displayed in black.

In the transmissive portion 13 of the on pixel 11, between the front and back polarizing plates 20 and 30, the front and back retardation plates 40 and 50, having the same retardation value and arranged such that their slow axes are orthogonal to each other, sandwich the liquid crystal layer 3 whose retardation is substantially zero. An external light that enters the transmissive portion 13 having such a structure is completely absorbed by the polarizing plates 20 and 30 likewise a case where an external light permeates through only the two polarizing plates whose transmission axes are orthogonal to each other. Therefore, the external light that enters the transmissive portion 13 of the on pixel 11 is not emitted frontward as a stray light.

As described above, in the reflective color display performed by the liquid crystal display device of the present embodiment, the light intensity is improved by providing the holes 91 to 93 in the color filter elements 9R, 9G, and 9B. And by setting the opening rates of the holes 91 to 93 in accordance with the color sensitivity, the white point and the brightness are improved. Further, the liquid crystal layer thickness d1 is optimally set such that the plane of polarization of a light that goes and returns through the liquid crystal layer 3 and finally enters the front polarizing plate 20 is parallel to the transmission axis 20a in the off time and is parallel to the absorption axis in the on time. Due to this, the display contrast is improved.

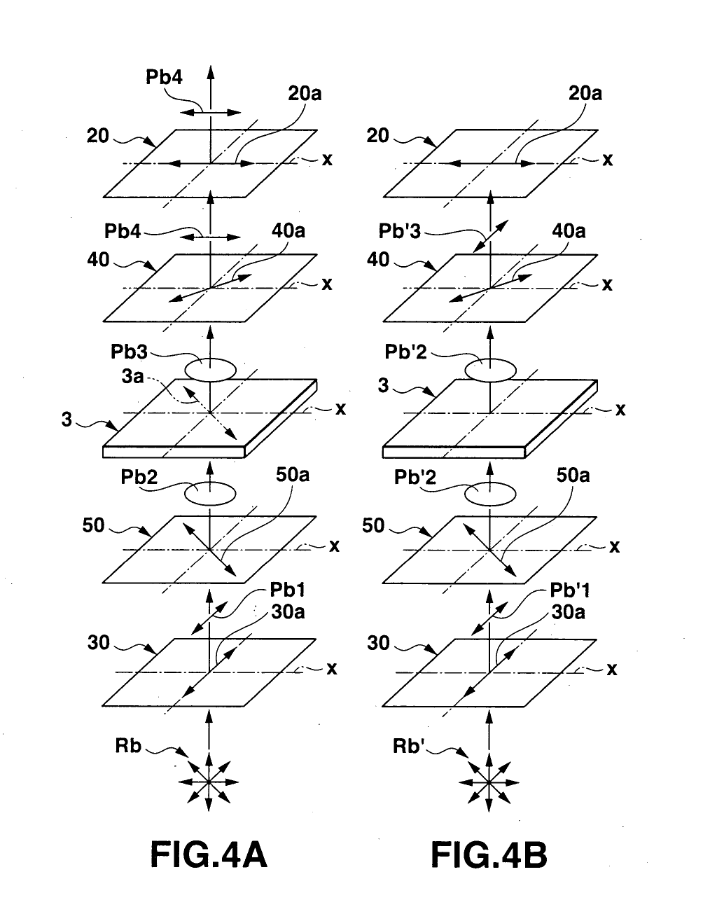

Next, the operation in the transmissive display performed by the liquid crystal display device of the present embodiment will be explained with reference to FIG. 2 and FIGS. 4A and 4B. FIGS. 4A and 4B are diagrams showing the states where a light is polarized in the transmissive display. FIG. 4A shows the off time and FIG. 4B shows the on time.

In FIG. 2, of a backlight that enters the light guiding plate 201 from the light emitting elements 202 (see FIG. 1), a backlight (non-polarized light) Rb emitted toward the off pixel 11 turns into a linearly polarized light Pb1 having a plane of polarization parallel to the transmission axis 30a of the back polarizing plate 30 by transmitting through the back polarizing plate 30. Then, the linearly polarized light Pb1 enters the back retardation plate 50. The linearly polarized light Pb1 is provided with a retardation of λ/4 by transmitting through the back retardation plate 50. Due to this, the linearly polarized light Pb1 turns into a circularly polarized light Pb2, enters the liquid crystal cell 10, and enters the liquid crystal layer 3 being in the off time.

The liquid crystal layer 3 in the transmissive portion 13 has a thickness d2 and has retardation Δn·d2 corresponding to a phase difference of λ/2 when in the off time. Accordingly, the circularly polarized light Pb2 is further provided with a retardation of λ/2 by transmitting through the liquid crystal layer 3 which is in the off time and whose slow axis 3a is parallel to the slow axis 50a of the back retardation plate 50. As a result, a retardation of total (¾)λ is provided while the light changes from the linearly polarized light Pb1 to a circularly polarized light Pb3. The circularly polarized light Pb3 is colored in red by transmitting through the red color filter element 9R, and the emitted from the liquid crystal cell 10.

The colored circularly polarized light Pb3 permeates through the front retardation plate 40 having the slow axis 40 orthogonal to the slow axis 3a of the liquid crystal layer 3 and providing a retardation of λ/4 to a transmitting light. Due to this, the retardation of λ/4 provided to the circularly polarized light Pb3 is canceled. As a result, the plane of polarization of the light is rotated by 90° from when the linearly polarized light Pb1 permeates through the back polarizing plate 30. That is, the circularly polarized light Pb3 turns into a linearly polarized light Pb4 having a plane of polarization parallel to the “x” axis, and is emitted to the outside. Since the linearly polarized light Pb4 has a plane of polarization parallel to the transmission axis 20a of the front polarizing plate 20, it permeates the front polarizing plate 20 without being absorbed thereinto, and is emitted frontward to the viewing side. Due to this, the pixel corresponding to the pixel area 11 is displayed in red brightly.

On the other hand, a backlight Rb′ that enters the transmissive portion 13 in the on pixel 11 in which, for example, the blue color filter element 9B is provided receives the same effects as those in the off pixel 11 until it enters the liquid crystal layer 3, as shown in FIG. 4B. That is, the backlight Rb′ turns into a linearly polarized light Pb′1, turns into a circularly polarized light Pb′2, and enters the liquid crystal layer 3 being in the on time. Since the retardation (Δn·d2) possessed by the liquid crystal layer 3 being in the on time is substantially zero, the circularly polarized light Pb′2 that enters the liquid crystal layer 3 permeates through the liquid crystal cell 10 without being changed, and enters the front retardation plate 40. The front retardation plate 40 is arranged such that its slow axis 40a is orthogonal to the slow axis 50a of the back retardation plate 50. Due to this, one of the front retardation plate 40 and back retardation plate 50 cancels the retardation provided by the other of the two to the transmitting light. Therefore, by the circularly polarized light Pb′2 transmitting through the front retardation plate 40, the retardation provided to the circularly polarized light Pb′2 by the back retardation plate 50 is canceled. That is, the circularly polarized light Pb′2 transmitting through the front retardation plate 40 turns into a linearly polarized light Pb′3 having a plane of polarization parallel to the plane of polarization of the former linearly polarized light Pb′1.

The plane of polarization of the linearly polarized light Pb′3 is parallel to the absorption axis (unillustrated) of the front polarizing plate 20. Therefore, the linearly polarized light Pb′3 is almost completely absorbed by the front polarizing plate 20. Accordingly, the pixel corresponding to the on pixel 11 is displayed clearly in black.

As described above, the transmissive display performed by the liquid crystal display device of the present embodiment is the normally white display where the on pixel 11 is displayed in black. Further, in the off pixel 11, light absorption by the front polarizing plate 20 is prevented as much as possible. Furthermore, since an incident light is almost completely absorbed by the front and back polarizing plates 20 and 30 in the transmissive portion 13 of the on pixel 11, color transmissive display having a high contrast can be realized.

[Second Embodiment]

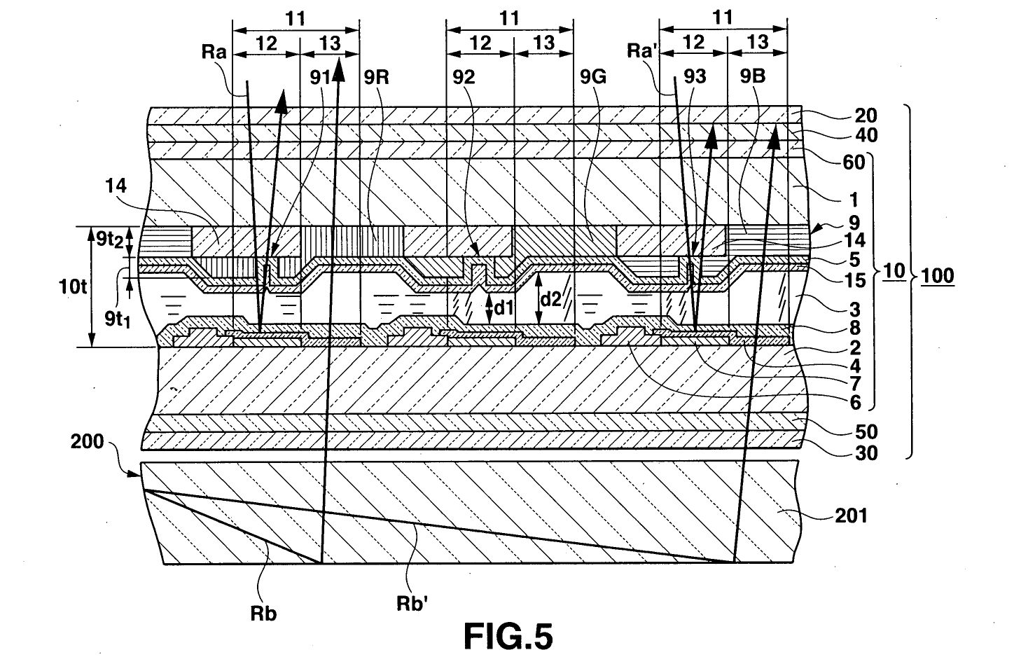

Next, a second embodiment of the present invention will be explained with reference to FIG. 5. In the embodiments to be described below, the same components as those in the first embodiment will be denoted by the same reference numerals as those in the first embodiment, and explanation for such components will be omitted.

In the liquid crystal display device of the present embodiment, liquid crystal layer thickness adjusting layers 14 are respectively provided to at least the regions corresponding to the reflective portions 12 in the regions on the internal surface of the front transparent substrate 1 except the transmissive portions 13. A color filter layer 9 is stacked on the almost entire internal surface of the front transparent substrate 1 so as to cover the liquid crystal layer thickness adjusting layers 14.

The liquid crystal layer thickness adjusting layers 14 of the present embodiment are made of a transparent organic material such as acryl resin and the like, or a transparent inorganic material such as ITO and the like as well as the liquid crystal layer thickness adjusting layers 14 of the first embodiment. The liquid crystal layer thickness adjusting layers 14 can be easily formed by photolithography or the like so as to cover the necessary regions.

The color filter layer 9 comprises color filter elements 9R, 9B, and 9G which are provided in the pixel areas 11 in a predetermined order. Each of the color filter elements 9R, 9G, and 9B is formed such that a layer thickness 9t1 in the reflective portion 12 is thinner than a layer thickness 9t2 in the transmissive portion 13.

For example, the thickness 9t1 of the red color filter element 9R in the reflective portion 12 is set such that a light Ra that enters the reflective portion 12 of the red color filter element 9R from the front of the liquid crystal display element 100, then is reflected by the reflective film 7, and again permeates through the red color filter element 9R, i.e. a light Ra that goes and returns through the red color filter element 9R in the reflective portion 12 can be emitted toward outside as a colored light having a sufficiently high color purity and intensity. Further, for example, the thickness 9t2 of the red color filter element 9R in the transmissive portion 13 is set such that a light Rb that enters the red color filter element 9R from the back of the liquid crystal display element 100, permeates through the red color filter element 9R, and is emitted frontward can be emitted as a colored light having a sufficiently high color purity and intensity. This layer thickness constitution is also applied to the other green and blue color filter elements 9G and 9B.

Holes 91 to 93 for improving the white point and brightness in the reflective display are provided in the color filter elements 9R, 9G, and 9B in the reflective portions 12 respectively, likewise the first embodiment.

An opposing electrode 5 and a front aligning film 15 are formed on the color filter layer 9, so as to cover the inner surface of the holes 91 to 93 and the entire surface of the color filter layer 9, with predetermined thin thicknesses thereof.

The liquid crystal layer thicknesses (gap) d1 and d2 in the reflective portion 12 and transmissive portion 13 in each pixel area 11 are optimally set such that high contrast color display can be realized likewise the first embodiment. In the present embodiment, the liquid crystal layer thickness d1 in the reflective portion 12 is set to be a value that makes Δn·d1 of the liquid crystal layer in the reflective portion 12 provide a retardation of λ/4 to a transmitting light. Further, the liquid crystal layer thickness d2 in the transmissive portion 13 is set to be value that makes Δn·d2 of the liquid crystal layer in the transmissive portion 13 provide a retardation of λ/2 to a transmitting light.

The thickness of each liquid crystal layer thickness adjusting layer 14 is set such that sufficiently high color purity and light intensity can be obtained in both of the reflective portion 12 and transmissive portion 13. Specifically, the thickness of the liquid crystal layer thickness adjusting layer 14 is set such that the liquid crystal layer thickness d2 in the transmissive portion 13 that makes the liquid crystal layer provide a retardation of λ/2 to a transmitting light and the liquid crystal layer thickness d1 in the reflective portion 12 that makes the liquid crystal layer provide a retardation of λ/4 to a transmitting light can be obtained.

According to the liquid crystal display device in the present embodiment which is structured as described above, an excellent color display quality with sufficiently high color purity and light intensity and a high contrast can be obtained in both of the reflective display and the transmissive display, by substantially the same operation as the liquid crystal display device in the first embodiment. In this case, the thickness 9t1 of the color filter layer 9 in the reflective portion 12 and the thickness 9t2 of the color filter layer 9 in the transmissive portion 13 are optimally set. This is different from the first embodiment where the thickness of the color filter layer 9 is uniform in the reflective portion 12 and in the transmissive portion 13. Due to this difference, according to the second embodiment, an excellent color display quality with as high light intensity and color purity as possible can be obtained in both of the reflective display and transmissive display.

[Third Embodiment]

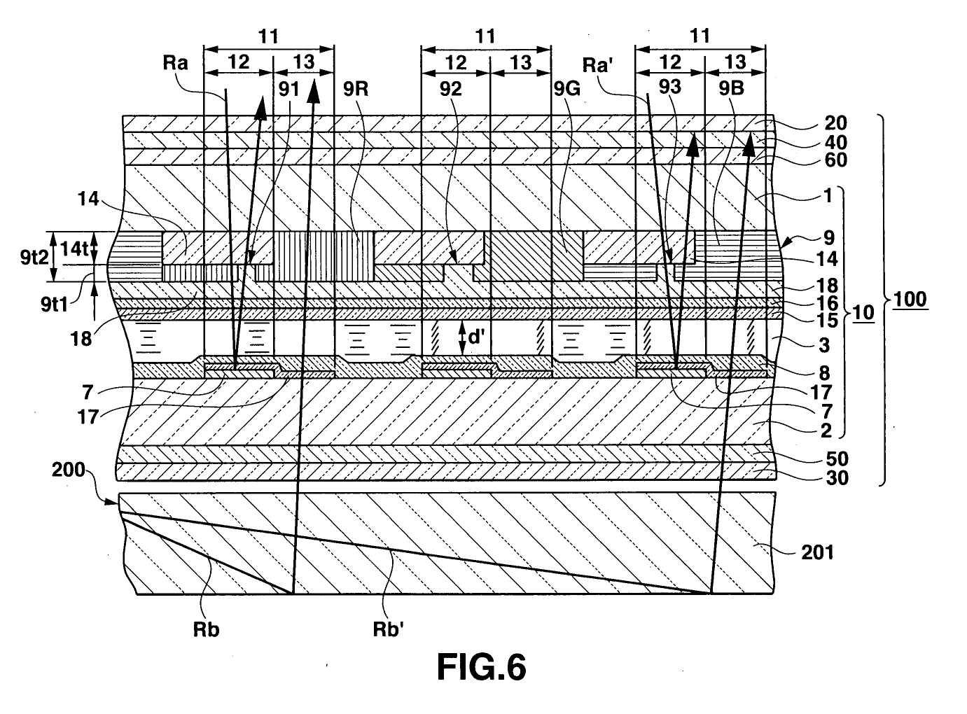

A third embodiment of the present invention will now be explained with reference to FIG. 6.

The liquid crystal display device according to the present embodiment is a simple matrix type semi-transmissive reflective color liquid crystal display device. The liquid crystal layer 3 is constituted by STN (Super Twisted Nematic) liquid crystal having a large twist angle of 180° to 360°.

A plurality of stripe-shaped scanning electrodes 16 are formed in parallel with one another on the internal surface of the front transparent substrate 1. A plurality of stripe-shaped signal electrodes 17 are formed in parallel with one another on the internal surface of the back transparent substrate 2 in a direction perpendicular to the scanning electrodes 16. Due to this, the pixel areas 11, which are formed in portions at which the electrodes 16 and electrodes 17 are opposed to each other, are arranged in a matrix form.

A reflective film 7 made of the same material as that in the first embodiment is provided between the back transparent substrate 2 and each signal electrode 17. The reflective film 7 is provided on a predetermined region on one side of the signal electrode 17 in the width direction of the signal electrode 17. Due to this, in each pixel electrode 11, one region of the signal electrode 17 in which the reflective film 7 is provided forms the reflective portion 12, and the other region of the signal electrode 17 in which the reflective film 7 is not provided forms the transmissive portion 13. In the present embodiment, the reflective film 7 is formed such that the reflective portion 12 is slightly broader than the transmissive portion 13.

Liquid crystal layer thickness adjusting layers 14 are provided on the internal surface of the front transparent substrate 1 in at least regions corresponding to the reflective portions 12 in the regions except the transmissive portions 13. The liquid crystal layer thickness adjusting layers 14 of the present embodiment are made of a transparent organic material such as acryl resin and the like, or a transparent inorganic material such as ITO and the like, likewise the liquid crystal layer thickness adjusting layers 14 in the first embodiment. The liquid crystal layer thickness adjusting layers 14 can be easily formed by photolithography or the like so as to cover the necessary regions.

A color filter layer 9 is stacked on the almost entire internal surface of the front transparent substrate 1 so as to cover the liquid crystal layer thickness adjusting layers 14. The color filter layer 9 is constituted by red, green, and blue color filter elements 9R, 9G, and 9B which are formed in a stripe shape to correspond to the signal electrodes 17. Each of the color filter elements 9R, 9G, and 9B is formed such that a thickness 9t1 in the reflective portion 12 is thinner than a thickness 9t2 in the transmissive portion 13.

The filter layer thickness 9t1 in the reflective portion 12 is set such that an external light Ra that goes and returns through the red color filter element 9R in the reflective portion 12 can be emitted to the outside as a colored light having a sufficiently high color purity and intensity, likewise the second embodiment. The filter layer thickness 9t2 in the transmissive portion 13 is set such that a backlight Rb that enters the region corresponding to the reflective portion 12 in the red color filter element 9R from the back, permeates through the red color filter element 9R, and is then emitted forward can be emitted to the outside as a colored light having a sufficiently high color purity and intensity. This layer thickness constitution is likewise applied to the other green and blue color filter elements 9G and 9B.

Holes 91 to 93 for improving the white point and brightness in the reflective display are provided in the color filter elements 9R, 9G, and 9B in the reflective portions 12, likewise the first and second embodiments.

In the present embodiment, a protective film 18 is formed so as to cover the color filter layer 9. The protective film 18 is provided for filling the holes 91 to 93 provided in the color filter elements 9R, 9G, and 9B to obtain flat surfaces. The above-described plurality of scanning electrodes 16 are provided in parallel with one another with a predetermined pitch therebetween on the flat surface of the protective film 18. A front aligning film 15 is stacked uniformly on the protective film 18 so as to cover the scanning electrodes 16. Due to this, an STN liquid crystal layer 3 whose thickness is substantially uniform in the reflective portion 12 and the transmissive portion 13 is obtained.

The thickness d′ of the STN liquid crystal layer 3 of the present embodiment is optimally set such that color display with as high contrast as possible can be realized in both of the reflective display and the transmissive display.

However, since the STN liquid crystal layer 3 causes a birefringence to a light transmitting therethrough, an incident light that enters the STN liquid crystal layer 3 is emitted from the STN liquid crystal layer 3 as an elliptically polarized light. Due to this, it is impossible to provide a linearly polarized light which is parallel to the transmission axis or absorption axis of the front polarizing plate 20 to the front polarizing plate 20, no matter how optimally the liquid crystal layer thicknesses in the reflective portion 12 and transmissive portion 13 are set separately. Because of this, according to the present embodiment, the liquid crystal layer thickness d′ in the reflective portion 12 and transmissive portion 13 is set substantially uniform.

Δn·d′ based on the thickness d′ of the STN liquid crystal layer 3, the aligning treatment directions of the aligning films 8 and 15 on both sides of the STN liquid crystal layer 3, the degree of the retardations provided to a transmitting light by the front and back retardation plates 40 and 50, and the arrangement of the optical axes such as the slow axes of the front and back retardation plates 40 and 50 are set such that when an elliptically polarized light emitted from the liquid crystal layer 3 enters the front polarizing plate 20, the plane of polarization of the elliptically polarized light is as close as possible to the plane of polarization of a linearly polarized light that is parallel to the transmission axis or the absorption axis of the front polarizing plate 20.

In a case where the thickness of the liquid crystal layer 3 is uniform as in the present embodiment, there is no need of forming a step between the reflective portion 12 and the transmissive portion 13 on the surface on which the scanning electrodes 16 are formed, i.e. on the surface of the protective film 18 according to the present embodiment. Accordingly, the thin-film-like scanning electrodes 16 can be easily formed on the flat surface of the protective film 18, improving the product yield.

The thickness of the above-described liquid crystal layer thickness adjusting layer 14 is set such that the surface of the color filter layer 9 becomes flat if the thicknesses 9t1 and 9t2 of the color filter layer 9 are set so as to be able to obtain sufficiently high color purity and light intensity in both of the reflective portion 12 and the transmissive portion 13, and such that the liquid crystal layer thickness d′ uniform between the reflective portion 12 and the transmissive portion 13 can realize color display with as high contrast as possible in both of the reflective display and the transmissive display.

The protective film 18 may be omitted and the scanning electrodes 16 may be formed directly on the flat surface of the color filter layer 9 as in the second embodiment.

According to the liquid crystal display device of the present embodiment which is structured as described above, an external light Ra that goes and returns through the liquid crystal display element 100 receives a birefringence effect from the front retardation plate 40 and the liquid crystal layer 3 in both of the going path and returning path. A backlight Rb that permeates one-directionally through the liquid crystal display element 100 receives a birefringence effect from the back retardation plate 50, the liquid crystal layer 3, and the front retardation plate 40 in the transmitting light path. Due to this, each of the external light Ra and the backlight Rb is turned into an elliptically polarized light close to a linearly polarized light having a plane of polarization parallel to the transmission axis 20a or the absorption axis (unillustrated) of the front polarizing plate 20, and enters the front polarizing plate 20. As a result, in both of the reflective display and the transmissive display, the difference, between the on time and off time of the liquid crystal layer 3, in the intensity of the lights emitted from the front polarizing plate 20 to the viewing side (forward), that is, display contrast can be secured sufficiently highly. Accordingly, in both of the reflective display and the transmissive display, an excellent color display can be realized which achieves as high contrast as possible, and also achieves high color purity and light intensity due to the use of the color filter 9 having the optimally set thickness 9t1 in the reflective portion 12 and the optimally set thickness 9t2 in the transmissive portion 13.

[Fourth Embodiment]

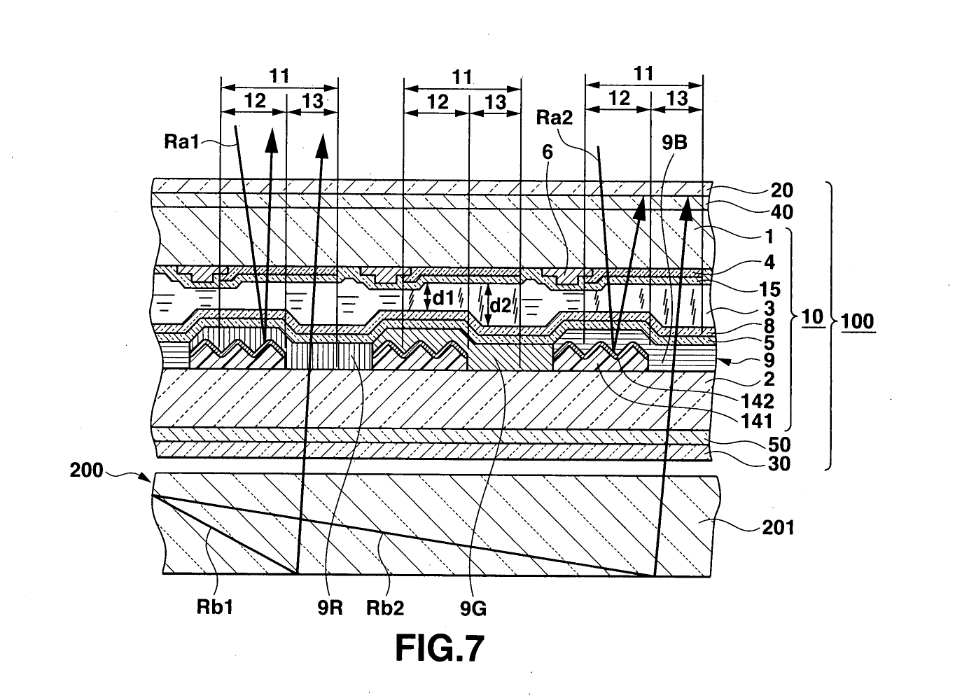

Next, a forth embodiment of the present invention will be explained with reference to FIG. 7.

A liquid crystal display element 101 of the present embodiment is an active matrix type liquid crystal display device. In the liquid crystal display element 101, liquid crystal layer thickness adjusting layers 141 and scattering reflective layers 142 both having depressions and protrusions on the surfaces thereof are provided on a substrate which is opposed to a substrate on which TFTs 6 are formed. A color filter 901 is formed on the scattering reflective layers 142. The substrate on which the TFTs 6 are formed is used as a front substrate which is arranged on the viewing side. Since the other components are substantially the same as those in the first to third embodiments, those components will be denoted by the same reference numerals and explanation for these components will be omitted.

In this liquid crystal display device, the liquid crystal layer thickness adjusting layers 141 are formed on the internal surface of the back transparent substrate 2 so as to correspond to the pixel electrodes 4 formed on the front transparent substrate 1. Each liquid crystal layer thickness adjusting layer 141 is arranged on a region corresponding to approximately 1/2 of each pixel area 11. Minute depressions and protrusions are formed in the surface (the surface facing toward the liquid crystal layer 3) of each liquid crystal layer thickness adjusting layer 141. In FIG. 7, the depressions and protrusions are shown more largely than they actually are.

A thin film made of metal such as aluminum, silver, silver-palladium alloy and the like is formed on the surfaces of the depressions and protrusions of the liquid crystal layer thickness adjusting layer 141 as the scattering reflective layer 142 by spattering or vapor deposition. In this case, the scattering reflective layer 142 is formed to have a thin thickness of approximately 1000 to 1500 Å. Therefore, minute depressions and protrusions parallel to the surfaces of the depressions and protrusions of the liquid crystal layer thickness adjusting layer 141 are also formed in the surface of the scattering reflective layer 142. In order for the lights reflected by the scattering reflective surface having these minute depressions and protrusions not to interfere with each other, that is, in order to randomly reflect an incident light, it is preferred that the depressions and protrusions be arranged not regularly but randomly.

The color filter layer 9 is stacked on the back transparent substrate 2 so as to cover he scattering reflective layers 142. The color filter elements 9R, 9G, and 9B of the color filter layer 9 are arranged in a predetermined order in the pixel areas 11 in which the pixel electrodes 4 are arranged. Due to this, one pixel area 11 is constituted by a reflective portion 12 in which, for example, the red color filter element 9R is stacked on the scattering reflective layer 142, and a transmissive portion 13 in which the same red color filter element 9R is stacked directly on the internal surface of the back transparent substrate 2. The thickness of the red color filter element 9R in the reflective portion 12 is set thinner than the thickness thereof in the transmissive portion 13. Specifically, the filter thicknesses in the transmissive portion 13 and the reflective portion 12 are set such that the color characteristics of the color display in the transmissive portion 13 and in the reflective portion 12 will be optimal.

The operation of the liquid crystal display device structured as described above is almost the same as that of the first embodiment. Therefore, according to the liquid crystal display device of the fourth embodiment, in both of the reflective display and the transmissive display, not only the image blur and reduction in the light intensity due to scattered lights can be removed, but also an excellent color display quality with high color purity and light intensity, and also with high contrast can be realized.

The liquid crystal display device of the present invention is not limited to the above-described first to fourth embodiments.

For example, in addition to the TN liquid crystal layer, liquid crystal layers having various alignments such as homogeneous alignment in which the liquid crystal molecules are aligned substantially in parallel with a pair of substrates without being twisted between the substrates in a non-electric field state, can be used.

That is, the optical conditions such as the degree of the retardations provided by the front and back retardation plates to a transmitting light, the arrangement of the slow axes of the front and back retardation plates, the arrangement of the transmission axes of the front and back polarizing plates, the twist angle of the liquid crystal layer and directions of the aligning treatment, etc. may be set optimally such that a retardation at which the difference, between the on time and off time of the liquid crystal layer, in the intensity of the light emitted to the viewing side (frontward), i.e. the display contrast is the largest can be obtained in the going and returning light paths of an external light and also in the light path of a transmitting backlight.

In the above-described embodiments, substantially a half of each pixel area is the reflective portion and the remaining half is the transmissive portion. However, the reflective portion and the transmissive portion can be formed to have arbitrary shapes and have an arbitrary area ratio in accordance with the usage purposes of the liquid crystal display device. Further, one or both of the reflective portion and the transmissive portion may be formed in a plural number in one pixel area. The color filter layer and the liquid crystal layer thickness adjusting layers shown in the above-described embodiments may be provided on the internal surface of the back transparent substrate.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-097982 filed on Apr. 1, 2003 and including specification, claims, drawings and summary. The disclosure of the above Japanese Patent Application is incorporated herein by reference in its entirety.

What is claimed is:

1. A liquid crystal display device comprising:
a liquid crystal element which includes
a front substrate which is arranged at a front side from where a screen is viewed,
a back substrate which is arranged at a back of said front substrate so as to be opposed to said front substrate,
at least one first electrode which is formed on one of an internal surface of said front substrate and an internal surface of said back substrate, the internal surfaces being opposed to each other,
at least one second electrode which is arranged on the other of the internal surfaces opposed to each other so as to be opposed to said at least one first electrode, thereby forming at least one pixel in an area where said at least one first electrode and said at least one second electrode are opposed to each other,
a liquid crystal layer which is sandwiched between said front substrate and said back substrate,
at least one reflective film which is provided at a back of said liquid crystal layer so as to correspond to a part of said at least one pixel, such that a reflective portion for reflecting an incident light and a transmissive portion which is a region other than said reflective portion and through which an incident light permeates are formed in said at least one pixel,
a color filter which is provided on one of the internal surfaces opposed to each other so as to correspond to said at least one pixel, and
a liquid crystal layer thickness adjusting layer which is provided on at least a region corresponding to said reflective portion between said front substrate and said back substrate, in order to adjust a thickness of said liquid crystal layer in said reflective portion with respect to a thickness of said liquid crystal layer in said transmissive portion in accordance with a thickness of said color filter;
a front polarizing plate and a back polarizing plate which are arranged at a front and a back of said liquid crystal element; and
a backlight which is arranged at a back of said back polarizing plate.

2. The liquid crystal display device according to claim 1, wherein
a thickness of said liquid crystal layer thickness adjusting layer is set such that a thickness of said color filter in said reflective portion is thinner than a thickness of said color filter in said transmissive portion, and the thickness of said liquid crystal layer in said reflective portion is thinner than the thickness of said liquid crystal layer in said transmissive portion.

3. The liquid crystal display device according to claim 1, wherein
a thickness of said liquid crystal layer thickness adjusting layer is set such that a thickness of said color filter in said reflective portion is equal to a thickness of said color filter in said transmissive portion, and the thickness of said liquid crystal layer in said reflective portion is thinner than the thickness of said liquid crystal layer in said transmissive portion.

4. The liquid crystal display device according to claim 1, wherein
a thickness of said liquid crystal layer thickness adjusting layer is set such that a thickness of said color filter in said reflective portion is thinner than a thickness of said color filter in said transmissive portion, and the thickness of said liquid crystal layer in said reflective portion is equal to the thickness of said liquid crystal layer in said transmissive portion.

5. The liquid crystal display device according to claim 4, further comprising
a flattening film which formed on said color filter in order to flatten a surface of said color filter having different thicknesses.

6. The liquid crystal display device according to claim 4, wherein
said liquid crystal element is an STN (Super Twisted Nematic) liquid crystal display element.

7. The liquid crystal display device according to claim 1, wherein
said liquid crystal element comprises a homogeneous liquid crystal layer in which liquid crystal molecules are oriented substantially in parallel with surfaces of a pair of substrates without being twisted between the substrates in a non electric field state where no electric field is applied.

8. The liquid crystal display device according to claim 1, wherein
said liquid crystal layer thickness adjusting layer is made of a transparent insulation film.

9. The liquid crystal display device according to claim 1, wherein
said color filter has a hole which is formed by removing a part of said color filter, at a portion corresponding to said reflective portion of said at least one pixel.

10. The liquid crystal display device according to claim 9, wherein
said liquid crystal layer thickness adjusting layer fills said hole formed in said color filter.

11. The liquid crystal display device according to claim 9, wherein
said liquid crystal layer thickness adjusting layer is formed so as to fill said hole formed in said color filter and to cover said color filter.

12. The liquid crystal display device according to claim 1, wherein:
said liquid crystal layer thickness adjusting layer is formed on a surface of one of said front substrate and said back substrate; and
said color filter is formed such that a part of said color filter covers said liquid crystal layer thickness adjusting layer.

13. The liquid crystal display device according to claim 1, wherein
said reflective layer has a reflective surface on which depressions and protrusions are formed.

14. The liquid crystal display device according to claim 1, wherein:
a value of a product Δn·d1 of a thickness d1 and a refractive index anisotropy Δn of said liquid crystal layer in said reflective portion is set to a value which makes said liquid crystal layer provide a retardation of ¼ wavelength to a transmitting light in a non electric field state in which substantially no electric field is applied between electrodes opposed to each other; and
a value of a product Δn·d2 of a thickness d2 and a refractive index anisotropy Δn of said liquid crystal layer in said transmissive portion is set to a value that makes said liquid crystal layer provide a retardation of ½ wavelength to a transmitting light in the non electric field state.

15. The liquid crystal display device according to claim 14, further comprising
a front retardation plate and a back retardation plate which are respectively arranged between said front polarizing plate and said liquid crystal layer and between said back polarizing plate and said liquid crystal layer such that their slow axes are orthogonal to each other, and which provide a retardation of ¼ wavelength to a transmitting light,
wherein:
said front polarizing plate and said back polarizing plate are arranged such that their transmission axes are orthogonal to each other;
said front retardation plate is arranged so as to cancel the retardation provided to the transmitting light by said liquid crystal layer in the non electric field state.

16. The liquid crystal display device according to claim 15, further comprising
a scattering reflective plate which is arranged between said front polarizing plate and said liquid crystal layer and which scatters a transmitting light.

17. A liquid crystal display device comprising:
a liquid crystal element which includes
a front substrate which is arranged at a front side from where a screen is viewed,
a back substrate which is arranged at a back of said front substrate so as to be opposed to said front substrate,
at least one opposite electrode which is formed on an internal surface of said front substrate that is opposed to said back substrate,
a plurality of pixel electrodes which are arranged on an internal surface of said back substrate that is opposed to said front substrate so as to be opposed to said at least one opposite electrode, thereby forming a plurality of pixels in areas where said at least one opposite electrode and said plurality of pixel electrodes are opposed to each other,
a liquid crystal layer which is sandwiched between said front substrate and said back substrate,
a plurality of reflective films which are provided on the internal surface of said back substrate so as to respectively correspond to parts of said plurality of pixels, such that a reflective portion for reflecting an incident light and a transmissive portion which is a region other than said reflective portion and through which an incident light permeates are formed in each of said plurality of pixels,
a color filter which is provided on the internal surface of said front substrate that is opposed to said back substrate, so as to correspond to said plurality of pixels, and
liquid crystal layer thickness adjusting layers which are provided on regions corresponding to at least said reflective portions on said color filter formed on the internal surface of said front substrate that is opposed to said back substrate, in order to make a thickness of said liquid crystal layer in said reflective portions thinner than a thickness of said liquid crystal layer in said transmissive portions;
a front polarizing plate and a back polarizing plate which are arranged at a front and a back of said liquid crystal element; and
a backlight which arranged at a back of said back polarizing plate.

18. The liquid crystal display device according to claim 17, wherein:
thicknesses of said respective liquid crystal layer thickness adjusting layers are set such that a thickness of said color filter in said reflective portions is equal to a thickness of said color filter in said transmissive portions, and the thickness of said liquid crystal layer in said reflective portions is thinner than the thickness of said liquid crystal layer in said transmissive portion;
said color filter has holes formed by removing parts of said color filter, at portions corresponding to said reflective portions of said plurality of pixels; and
said liquid crystal layer thickness adjusting layers are formed so as to fill said holes formed in said color filter and to cover said color filter.

19. A liquid crystal display device comprising:
a liquid crystal element which includes
a front substrate which is arranged at a front side from where a screen is viewed,
a back substrate which is provided at a back of said front substrate so as to be opposed to said front substrate,
at least one opposite electrode which is formed on an internal surface of said front substrate that is opposed to said back substrate,
a plurality of pixel electrodes which are arranged on an internal surface of said back substrate that is opposed to said front substrate so as to be opposed to said at least one opposite electrode, thereby forming a plurality of pixels in areas where said at least one opposite electrode and said plurality of pixel electrodes are opposed to each other,
a liquid crystal layer which is sandwiched between said front substrate and said back substrate,
a plurality of reflective films which are provided on the internal surface of said back substrate so as to respectively correspond to parts of said plurality of pixels, such that a reflective portion for reflecting an incident light and a transmissive portion which is a region other than said reflective portion and through which an incident light permeates are formed in each of said plurality of pixels,
a liquid crystal layer thickness adjusting layer which is provided on the internal surface of said front substrate that is opposed to said back substrate so as to correspond to at least said reflective portions of said plurality of pixels, in order to make a thickness of said liquid crystal layer in said reflective portions thinner than a thickness of said liquid crystal layer in said transmissive portions, and
a color filter which covers said liquid crystal layer thickness adjusting layer on the internal surface of said front substrate that is opposed to said back substrate, and which is provided so as to correspond to said plurality of pixels;
a front polarizing plate and a back polarizing plate which are arranged at a front and a back of said liquid crystal element; and
a backlight which is arranged at a back of said back polarizing plate.

20. The liquid crystal display device according to claim 19, wherein
a thickness of said color filter in said reflective portions is thinner than a thickness of said color filter in said transmissive portions;
a thickness of said liquid crystal layer thickness adjusting layer is set such that the thickness of said liquid crystal layer in said reflective portions is thinner than the thickness of said liquid crystal layer in said transmissive portions; and
said color filter has holes formed by removing parts of said color filter, at portions corresponding to said reflective portions.
